(19) United States
(12) Patent Application Publication
(10) Pub. No.: US 2013/0248683 A1
(43) Pub. Date: Sep. 26, 2013

(54) DETECTING DEVICE AND METHOD FOR DETECTING AN EDGE OF TRANSPARENT MATERIAL

(71) Applicant: HITI DIGITAL, INC., New Taipei City (TW)

(72) Inventors: Tsung-Yueh Chen, Taipei City (TW); Chih-Chieh Lin, Taipei City (TW)

(73) Assignee: HITI DIGITAL, INC., New Taipei City (TW)

(21) Appl. No.: 13/692,975

(22) Filed: Dec. 3, 2012

(30) Foreign Application Priority Data
Mar. 22, 2012 (TW) 101109843

(51) Int. Cl. G01J 1/44

(52) U.S. Cl. CPC G01J 1/44
USPC 250/206

(57) ABSTRACT

A detecting device includes an actuating unit for driving a transparent material, a light source for emitting light to the transparent material driven by the actuating unit, a light sensor for sensing the light emitted from the light source as an edge of the transparent material is moved to different positions relative to the light source so as to generate a corresponding optical intensity signal, a transforming circuit coupled to the light sensor for transforming the optical intensity signal into a transforming signal, and a processing unit coupled to the transforming circuit for determining whether the edge of the transparent material is moved to a position between the light source and the light sensor according to the transforming signal transmitted from the transforming circuit.

### BACKGROUND OF THE INVENTION

1. Field of the Invention

The present invention relates to a detecting device and a method for detecting an edge of a transparent material, and more specifically, to a detecting device and a method for detecting an edge of a transparent material by level changes of an optical intensity signal.

2. Description of the Prior Art

Because a transparent material has a property of transparency, a light sensor cannot sense the transparent material passing by. Generally speaking, in order to sense the transparent material by the light sensor, an opaque material can be stuck on a side of the transparent material, a shading pattern can be printed in advance, or some special transparent ink capable of shading infrared light can be printed on the transparent material, so as to detect a relative position of the transparent material by the light sensor inside a machine. However, above-mentioned mechanisms need additional process for the transparent material resulting in increase of manufacturing cost and difficulty, so that products with the transparent material as a substrate can not be widely applied in identification.

### SUMMARY OF THE INVENTION

The present invention is to provide a detecting device and a method for detecting an edge of a transparent material to solve above problems.

According to the disclosure, a detecting device includes an actuating unit, a light source, a light sensor, a transforming circuit and a processing unit. The actuating unit is for driving a transparent material. The light source is for emitting light to the transparent material driven by the actuating unit. The light sensor is for sensing the light emitted from the light source as an edge of the transparent material is moved to different positions relative to the light source so as to generate a corresponding optical intensity signal. The transforming circuit is coupled to the light sensor for transforming the optical intensity signal into a transforming signal. The processing unit is coupled to the transforming circuit for determining whether the edge of the transparent material is moved to a position between the light source and the light sensor according to the transforming signal transmitted from the transforming circuit.

According to the disclosure, the light source is a light emitting diode, and the light sensor is an optical interrupter sensor.

According to the disclosure, the light source and the light sensor are disposed at opposite sides of the transparent material.

According to the disclosure, the light emitted from the light source is scattered by the edge of the transparent material as the edge of the transparent material is moved to the position between the light source and the light sensor so as to generate the minimum optical intensity signal by the light sensor.

According to the disclosure, the light source is a light emitting diode, and the light sensor is an optical reflective sensor.

According to the disclosure, the light source and the light sensor are disposed at the same side of the transparent material.

According to the disclosure, the light emitted from the light source is scattered by the edge of the transparent material as the edge of the transparent material is moved to the position between the light source and the light sensor so as to generate the maximum optical intensity signal by the light sensor.

According to the disclosure, the transforming circuit is for amplifying level changes of the optical intensity signal so as to generate the transforming signal.

According to the disclosure, a direction of movement of the transparent material driven by the actuating unit is substantially vertical to a direction of the light emitted from the light source.

According to the disclosure, a method for detecting an edge of a transparent material includes following steps: driving the transparent material, a light source emitting light to the transparent material, a light sensor sensing the light emitted from the light source as the transparent material is moved to different positions relative to the light source so as to generate a corresponding optical intensity signal, transforming the optical intensity signal generated by the light sensor into a transforming signal, and determining whether the edge of the transparent material is moved to a position between the light source and the light sensor according to the transforming signal.

The detecting device and the detecting method of the present invention can utilize the light sensor and the transforming circuit to detect and locate the edge of the transparent material directly for following locating procedure. There is no need to execute additional process on the transparent material to achieve the purpose of sensing the transparent material by the light sensor. As a result, the manufacturing cost and difficulty can be reduced, and products with the transparent material as a substrate can be widely applied in identification.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a detecting device according to a preferred embodiment of the present invention.

FIG. 2 is a flowchart of the detecting device detecting an edge of a transparent material according to the preferred embodiment of the present invention.

FIG. 3 to FIG. 5 are respectively diagrams of a light source, a light sensor and the transparent material in different positions according to the preferred embodiment of the present invention.

FIG. 6 is a diagram of a transforming circuit transforming an optical intensity signal into a transforming signal according to the preferred embodiment of the present invention.

FIG. 7 to FIG. 9 are respectively diagrams of the light source, the light sensor and the transparent material in different positions according to another embodiment of the present invention.

### DETAILED DESCRIPTION

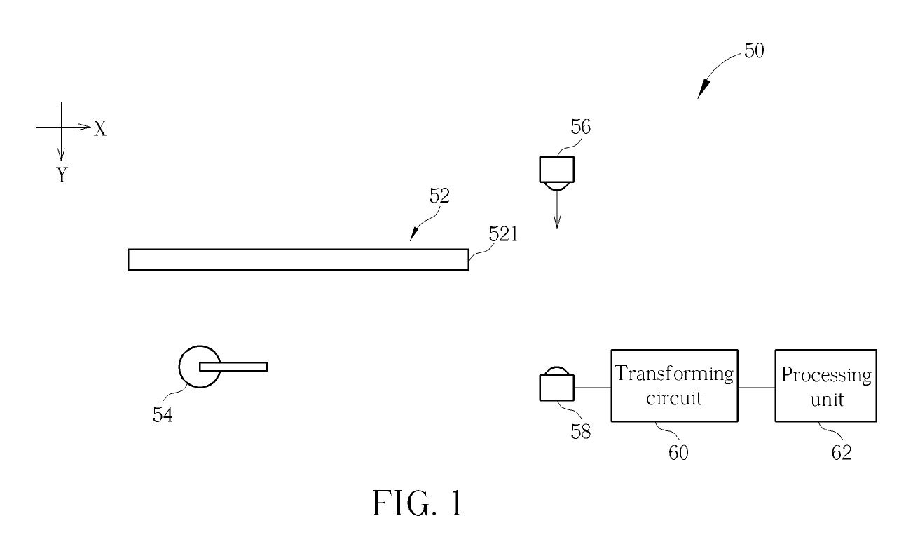

Please refer to FIG. 1. FIG. 1 is a diagram of a detecting device 50 according to a preferred embodiment of the present invention. The detecting device 50 is for detecting a position of an edge 521 of a transparent material 52 as a basis for locating. For example, the transparent material 52 can be a transparent card. As the detecting device 50 detects the transparent card, it can continue to print the card or read data of the card. For example, an Automated Teller Machine (ATM) with the detecting device 50 is capable of detecting the transparent card passing by, and then actuating a function of reading the card. The detecting device 50 includes an actuating unit 54 for driving the transparent material 52 to move in a X-direction. The detecting device 50 further includes a light source 56 for emitting light in a Y-direction to the transparent material 52 driven by the actuating unit 54. A direction (X-direction) of movement of the transparent material 52 driven by the actuating unit 54 can be substantially vertical to a direction (Y-direction) of the light emitted from the light source 56, and the light source 56 can be a light emitting diode.

The detecting device 50 further includes alight sensor 58 for sensing the light emitted from the light source 56 as the edge 521 of the transparent material 521 is moved to different positions relative to the light source 56, so as to generate a corresponding optical intensity signal. The light sensor 58 can be an optical interrupter sensor or an optical reflective sensor. In addition, the detecting device 50 further includes a transforming circuit 60 coupled to the light sensor 58 for transforming the optical intensity signal generated by the light sensor 58 into a transforming signal, such as transforming an analog signal into a recognizable digital signal. For example, level changes of the optical intensity signal generated by the light sensor 58 are weak, so the transforming circuit 60 can be utilized for amplifying the level changes of the optical intensity signal so as to generate the transforming signal. Furthermore, the detecting device 50 further includes a processing unit 62 coupled to the transforming circuit 60 for determining whether the edge 521 of the transparent material 52 is moved to a position between the light source 56 and the light sensor 58 according to the transforming signal transmitted from the transforming circuit 60.

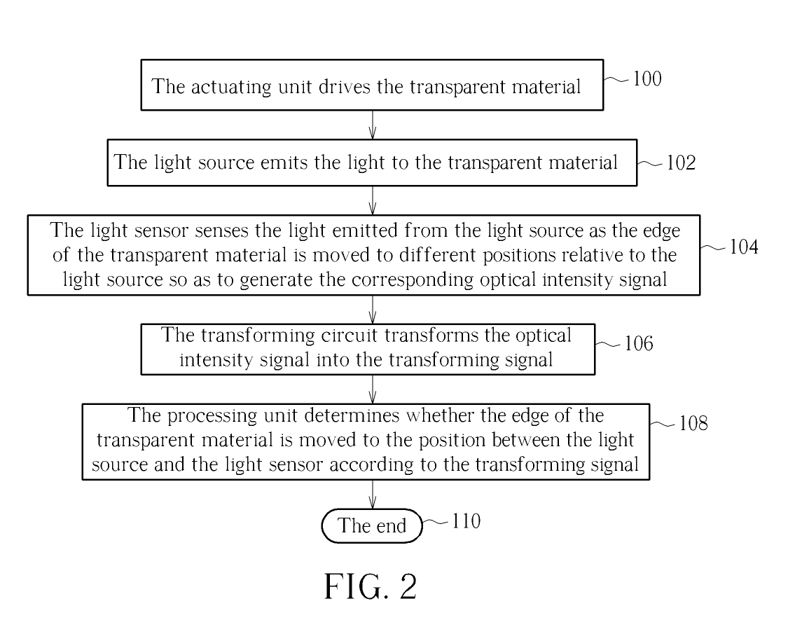

Please refer to FIG. 2. FIG. 2 is a flowchart of the detecting device 50 detecting the edge 521 of the transparent material 52 according to the preferred embodiment of the present invention. The method includes following steps:

Step 100: The actuating unit 54 drives the transparent material 52 to move in the X direction.

Step 102: The light source 56 emits the light in the Y direction to the transparent material 52 driven by the actuating unit 54.

Step 104: The light sensor 58 senses the light emitted from the light source 56 as the edge 521 of the transparent material 52 is moved to different positions relative to the light source 56 so as to generate the corresponding optical intensity signal.

Step 106: The transforming circuit 60 transforms the optical intensity signal generated by the light sensor 58 into the transforming signal.

Step 108: The processing unit 62 determines whether the edge 521 of the transparent material 52 is moved to the position between the light source 56 and the light sensor 58 according to the transforming signal transmitted from the transforming circuit 60.

Step 110: The end.

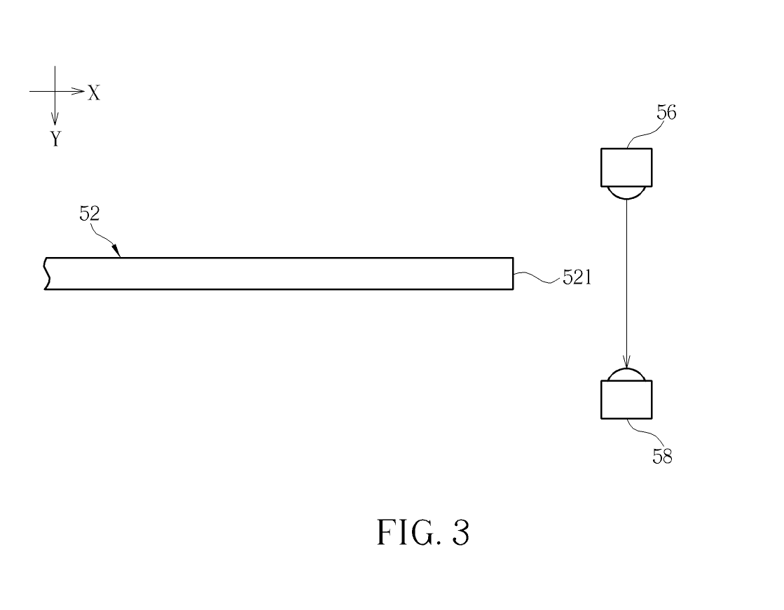

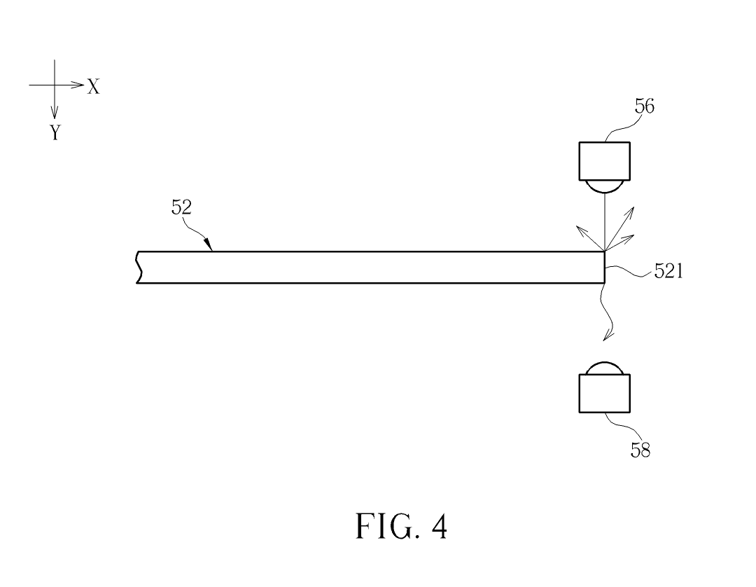

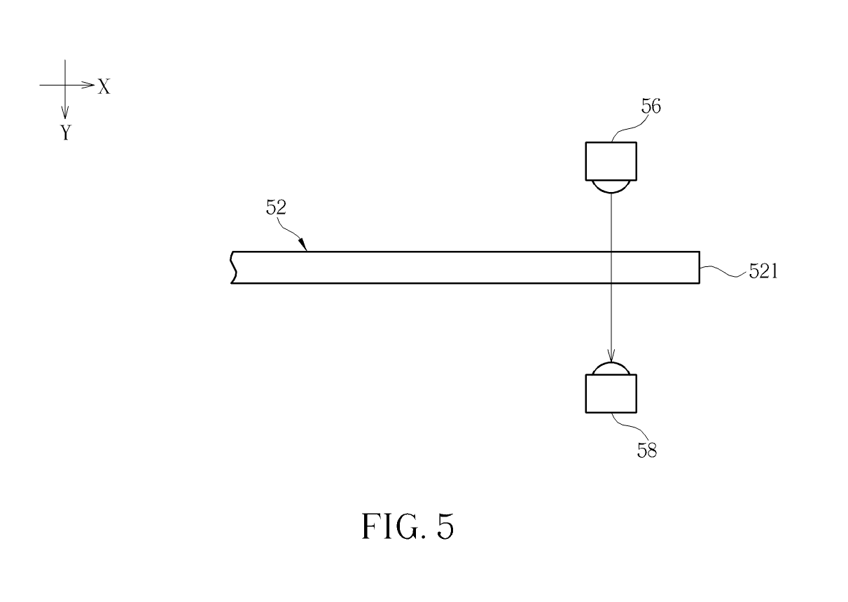

Detail description of above procedure is described herein. As the light sensor 58 is an optical interrupter sensor, the light source 56 and the light sensor 58 can be disposed at opposite sides of the transparent material 52. Please refer to FIG. 3 to FIG. 5. FIG. 3 to FIG. 5 are respectively diagrams of the light source 56, the light sensor 58 and the transparent material 52 in different positions according to the preferred embodiment of the present invention. The actuating unit 54 can drive the transparent material 52 to move in the X direction so that the transparent material 52 can pass between the light source 56 and the light sensor 58. As shown in FIG. 3, as the transparent material 52 has not been moved to the position between the light source 56 and the light sensor 58, the light emitted from the light source 56 can totally be sensed by the light sensor 58, which means that the light sensor 58 senses stronger light, so as to generate the stronger optical intensity signal. As shown in FIG. 4, as the edge 521 of the transparent material 52 is moved to the position between the light source 56 and the light sensor 58, because the edge 521 of the transparent material 52 is uneven and the light travels through the interface between different media, the light emitted from the light source 56 will scatter in other directions. As a result, the light sensor 58 senses weak light so as to generate a minimum optical intensity signal, and therefore it can be a basis for determining the edge 521 of the transparent material 52 is moved to the position between the light source 56 and the light sensor 58. As shown in FIG. 5, as the edge 521 of the transparent material 52 has passed through the position between the light source 56 and the light sensor 58 and the transparent material 52 itself is disposed between the light source 56 and the light sensor 58, because the transparent material 52 has a property of transparency, the light emitted from the light source 56 can totally penetrate the transparent material 52 and be sensed by the light sensor 58. That is, the light sensor 58 senses stronger light so as to generate the stronger optical intensity signal.

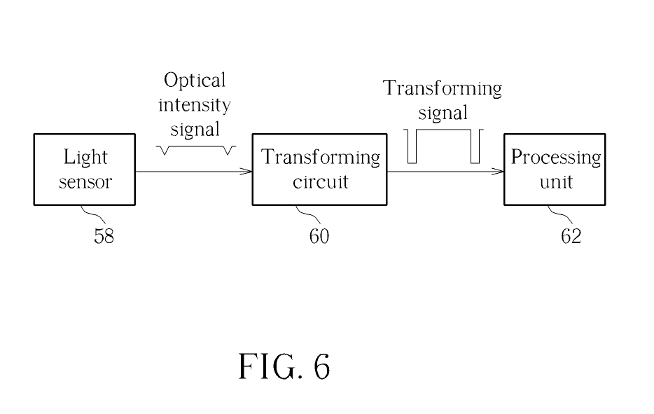

Please refer to FIG. 6. FIG. 6 is a diagram of the transforming circuit 60 transforming the optical intensity signal into the transforming signal according to the preferred embodiment of the present invention. Because the level changes of the optical intensity signal generated by the light sensor 58 are weak, in order to increase accuracy of determination, the transforming circuit 60 can be utilized for amplifying the level changes of the optical intensity signal so as to generate the transforming signal. And then the processing unit 62 can determine whether the edge 521 of the transparent material 52 is moved to the position between the light source 56 and the light sensor 58 according to the transforming signal transmitted from the transforming circuit 60. That is because the edge 521 of the transparent material 52 is uneven and the light travels through the interface between different media, the light emitted from the light source 56 will scatter in other directions. As a result, the light sensor 58 senses weak light so as to generate the minimum optical intensity signal. Therefore a position of the edge 521 of the transparent material 52 can be obtained according to a waveform of the level changes of the transforming signal. For example, a wave trough of the waveform corresponds the position of the edge 521 of the transparent material 52, and it can be a basis for determining the edge 521 of the transparent material 52 is moved to the position between the light source 56 and the light sensor 58.

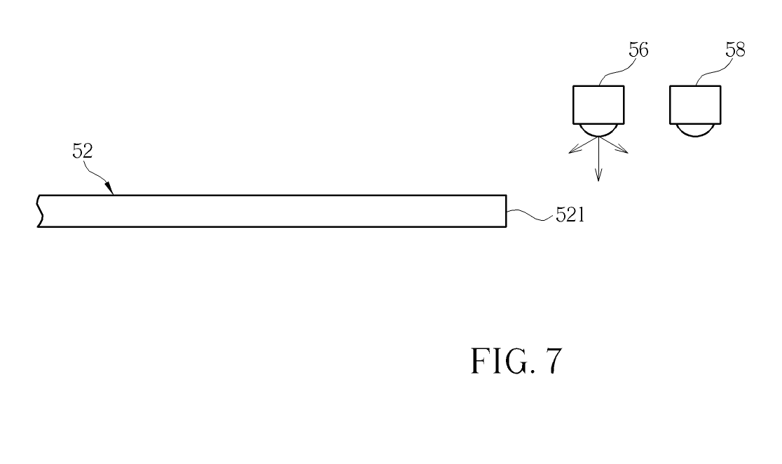

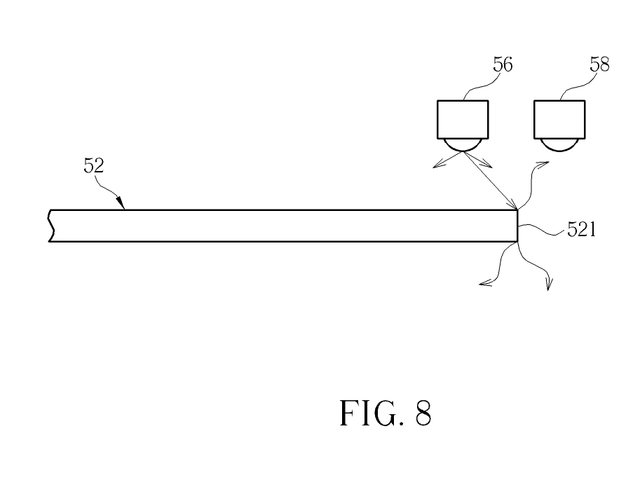

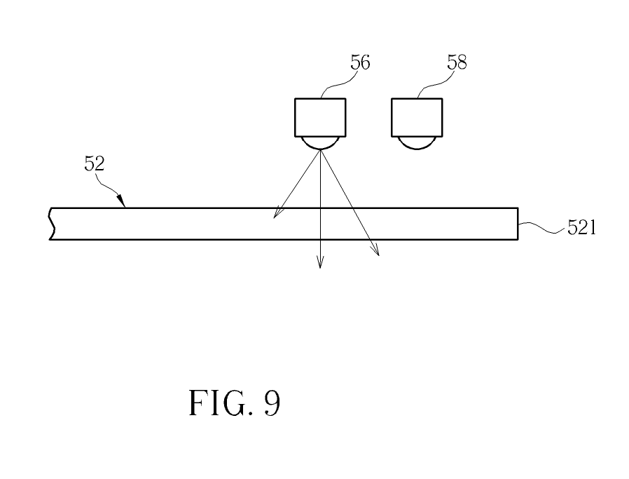

Moreover, the light sensor 58 of the present invention can selectively be an optical reflective sensor. Please refer to FIG. 7 to FIG. 9. FIG. 7 to FIG. 9 are respectively diagrams of the light source 56, the light sensor 58 and the transparent material 52 in different positions according to another embodiment of the present invention. The difference between this embodiment and the previous one is that the light source 56 and the light sensor 58 are both disposed at the same side of the transparent material 52 in this embodiment. As shown in FIG. 7, as the transparent material 52 has not been moved to the position between the light source 56 and the light sensor 58, the light emitted from the light source 56 totally cannot be sensed by the light sensor 58, which means that the light sensor 58 senses weaker light so as to generate a weaker optical intensity signal. As shown in FIG. 8, as the edge 521 of the transparent material 52 is moved to the position between the light source 56 and the light sensor 58, because the edge 521 of the transparent material 52 is uneven and the light travels through the interface between different media, the light emitted from the light source 56 will scatter in other directions. As a result, the light sensor 58 can sense the scattering light so as to generate a maximum optical intensity signal, and therefore it can be a basis for determining the edge 521 of the transparent material 52 is moved to the position between the light source 56 and the light sensor 58. As shown in FIG. 9, as the edge 521 of the transparent material 52 has passed through the position between the light source 56 and the light sensor 58, and the transparent material 52 itself is disposed between the light source 56 and the light sensor 58, because the transparent material 52 has a property of transparency, the light emitted from the light source 56 can totally penetrate the transparent material 52 and cannot be sensed by the light sensor 58. That is, the light sensor 58 senses weaker light so as to generate the weaker optical intensity signal. As for the operational principle of the transforming circuit 60 and the processing unit 62 is similar to the previous embodiment and is omitted herein for simplicity. Furthermore, the positions and amounts of the light source 56 and the light sensor 58 are not limited to above embodiments. For example, the present invention can include multiple sets of light sources and light sensors, and those components can be disposed at two ends of a travelling path of the transparent material 52 respectively, so as to locate the transparent material 52 more accurately, and it depends on practical design demand.

In contrast to the prior art, the detecting device and the detecting method of the present invention can utilize the light sensor and the transforming circuit to detect and locate the edge of the transparent material directly for following locating procedure. There is no need to execute additional process on the transparent material to achieve the purpose of sensing the transparent material by the light sensor. As a result, the manufacturing cost and difficulty can be reduced, and products with the transparent material as a substrate can be widely applied in identification.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A detecting device comprising:
an actuating unit for driving a transparent material;
a light source for emitting light to the transparent material driven by the actuating unit;
a light sensor for sensing the light emitted from the light source as an edge of the transparent material is moved to different positions relative to the light source so as to generate a corresponding optical intensity signal;
a transforming circuit coupled to the light sensor for transforming the optical intensity signal into a transforming signal; and
a processing unit coupled to the transforming circuit for determining whether the edge of the transparent material is moved to a position between the light source and the light sensor according to the transforming signal transmitted from the transforming circuit.

2. The detecting device of claim 1, wherein the light source is a light emitting diode, and the light sensor is an optical interrupter sensor.

3. The detecting device of claim 2, wherein the light source and the light sensor are disposed at opposite sides of the transparent material.

4. The detecting device of claim 2, wherein the light emitted from the light source is scattered by the edge of the transparent material as the edge of the transparent material is moved to the position between the light source and the light sensor so as to generate the minimum optical intensity signal by the light sensor.

5. The detecting device of claim 1, wherein the light source is a light emitting diode, and the light sensor is an optical reflective sensor.

6. The detecting device of claim 5, wherein the light source and the light sensor are disposed at the same side of the transparent material.

7. The detecting device of claim 5, wherein the light emitted from the light source is scattered by the edge of the transparent material as the edge of the transparent material is moved to the position between the light source and the light sensor so as to generate the maximum optical intensity signal by the light sensor.

8. The detecting device of claim 1, wherein the transforming circuit is for amplifying level changes of the optical intensity signal so as to generate the transforming signal.

9. The detecting device of claim 1, wherein a direction of movement of the transparent material driven by the actuating unit is substantially vertical to a direction of the light emitted from the light source.

10. A method for detecting an edge of a transparent material, comprising:
driving the transparent material;
a light source emitting light to the transparent material;
a light sensor sensing the light emitted from the light source as the transparent material is moved to different positions relative to the light source so as to generate a corresponding optical intensity signal;
transforming the optical intensity signal generated by the light sensor into a transforming signal; and
determining whether the edge of the transparent material is moved to a position between the light source and the light sensor according to the transforming signal.

11. The method of claim 10, further comprising disposing the light source and the light sensor at opposite sides of the transparent material.

12. The method of claim 11, wherein the light emitted from the light source is scattered by the edge of the transparent material as the edge of the transparent material is moved to the position between the light source and the light sensor so as to generate the minimum optical intensity signal by the light sensor.

13. The method of claim 10, further comprising disposing the light source and the light sensor at the same side of the transparent material.

14. The method of claim 13, wherein the light emitted from the light source is scattered by the edge of the transparent material as the edge of the transparent material is moved to the position between the light source and the light sensor so as to generate the maximum optical intensity signal by the light sensor.

15. The method of claim 11, wherein transforming the optical intensity signal into the transforming signal comprises amplifying level changes of the optical intensity signal so as to generate the transforming signal.

16. The method of claim 11, wherein a direction of driving the transparent material is substantially vertical to a direction of the light emitted from the light source.
